(19) United States
(12) Patent Application Publication
(10) Pub. No.: US 2026/0239251 A1
(43) Pub. Date: Aug. 13, 2026

(54) ADDITIONAL TIME OFFSET FOR RANDOM ACCESS CHANNEL PREAMBLE

(71) Applicant: Nokia Technologies Oy, Espoo (FI)

(72) Inventor: Fabian WIACEK, Warsaw (PL)

(21) Appl. No.: 19/473,414

(22) PCT Filed: Apr. 11, 2023
(86) PCT No.: PCT/EP2023/059400

§ 371 Date: Oct. 7, 2025

(51) Int. Cl. H04W 56/00; H04W 74/0833

(52) U.S. Cl. CPC H04W 56/0045; H04W 74/0833

(57) ABSTRACT

Disclosed is a method comprising applying an additional time offset to a transmission time of a random access channel preamble, wherein the additional time offset is different from timing corresponding to downlink channel timing adjustment; transmitting, to a radio access network node, the random access channel preamble according to the transmission time applied with the additional time offset; receiving, from the radio access network node, a random access response in response to transmitting the random access channel preamble, wherein the random access response comprises a timing advance command; determining a first uplink channel timing adjustment based on the timing advance command by compensating for the additional time offset applied for transmitting the random access channel preamble; and transmitting, to the radio access network node, a message by applying the first uplink channel timing adjustment compensated for the additional time offset.

### FIELD

The following example embodiments relate to wireless communication.

### BACKGROUND

In wireless communication, it is desirable to improve the security and privacy of the communication.

### BRIEF DESCRIPTION

The scope of protection sought for various example embodiments is set out by the independent claims. The example embodiments and features, if any, described in this specification that do not fall under the scope of the independent claims are to be interpreted as examples useful for understanding various embodiments.

According to an aspect, there is provided an apparatus comprising at least one processor, and at least one memory storing instructions that, when executed by the at least one processor, cause the apparatus at least to: apply an additional time offset to a transmission time of a random access channel preamble, wherein the additional time offset is different from timing corresponding to downlink channel timing adjustment; transmit, to a radio access network node, the random access channel preamble according to the transmission time applied with the additional time offset; receive, from the radio access network node, a random access response in response to transmitting the random access channel preamble, wherein the random access response comprises a timing advance command; determine a first uplink channel timing adjustment based on the timing advance command by compensating for the additional time offset applied for transmitting the random access channel preamble; and transmit, to the radio access network node, a message by applying the first uplink channel timing adjustment compensated for the additional time offset.

According to another aspect, there is provided an apparatus comprising: means for applying an additional time offset to a transmission time of a random access channel preamble, wherein the additional time offset is different from timing corresponding to downlink channel timing adjustment; means for transmitting, to a radio access network node, the random access channel preamble according to the transmission time applied with the additional time offset; means for receiving, from the radio access network node, a random access response in response to transmitting the random access channel preamble, wherein the random access response comprises a timing advance command; means for determining a first uplink channel timing adjustment based on the timing advance command by compensating for the additional time offset applied for transmitting the random access channel preamble; and means for transmitting, to the radio access network node, a message by applying the first uplink channel timing adjustment compensated for the additional time offset.

According to another aspect, there is provided a method comprising: applying an additional time offset to a transmission time of a random access channel preamble, wherein the additional time offset is different from timing corresponding to downlink channel timing adjustment; transmitting, to a radio access network node, the random access channel preamble according to the transmission time applied with the additional time offset; receiving, from the radio access network node, a random access response in response to transmitting the random access channel preamble, wherein the random access response comprises a timing advance command; determining a first uplink channel timing adjustment based on the timing advance command by compensating for the additional time offset applied for transmitting the random access channel preamble; and transmitting, to the radio access network node, a message by applying the first uplink channel timing adjustment compensated for the additional time offset.

According to another aspect, there is provided a computer program comprising instructions which, when executed by an apparatus, cause the apparatus to perform at least the following: applying an additional time offset to a transmission time of a random access channel preamble, wherein the additional time offset is different from timing corresponding to downlink channel timing adjustment; transmitting, to a radio access network node, the random access channel preamble according to the transmission time applied with the additional time offset; receiving, from the radio access network node, a random access response in response to transmitting the random access channel preamble, wherein the random access response comprises a timing advance command; determining a first uplink channel timing adjustment based on the timing advance command by compensating for the additional time offset applied for transmitting the random access channel preamble; and transmitting, to the radio access network node, a message by applying the first uplink channel timing adjustment compensated for the additional time offset.

According to another aspect, there is provided a computer readable medium comprising program instructions which, when executed by an apparatus, cause the apparatus to perform at least the following: applying an additional time offset to a transmission time of a random access channel preamble, wherein the additional time offset is different from timing corresponding to downlink channel timing adjustment; transmitting, to a radio access network node, the random access channel preamble according to the transmission time applied with the additional time offset; receiving, from the radio access network node, a random access response in response to transmitting the random access channel preamble, wherein the random access response comprises a timing advance command; determining a first uplink channel timing adjustment based on the timing advance command by compensating for the additional time offset applied for transmitting the random access channel preamble; and transmitting, to the radio access network node, a message by applying the first uplink channel timing adjustment compensated for the additional time offset.

According to another aspect, there is provided a non-transitory computer readable medium comprising program instructions which, when executed by an apparatus, cause the apparatus to perform at least the following: applying an additional time offset to a transmission time of a random access channel preamble, wherein the additional time offset is different from timing corresponding to downlink channel timing adjustment; transmitting, to a radio access network node, the random access channel preamble according to the transmission time applied with the additional time offset; receiving, from the radio access network node, a random access response in response to transmitting the random access channel preamble, wherein the random access response comprises a timing advance command; determining a first uplink channel timing adjustment based on the timing advance command by compensating for the additional time offset applied for transmitting the random access channel preamble; and transmitting, to the radio access network node, a message by applying the first uplink channel timing adjustment compensated for the additional time offset.

According to another aspect, there is provided an apparatus comprising at least one processor, and at least one memory storing instructions that, when executed by the at least one processor, cause the apparatus at least to: receive a random access channel preamble from a user equipment, wherein an additional time offset was applied to a transmission time of the random access channel preamble at the user equipment, wherein the additional time offset is different from timing corresponding to downlink channel timing adjustment; determine a timing advance command for the user equipment based on the random access channel preamble; transmit, to the user equipment, a random access response in response to receiving the random access channel preamble, wherein the random access response comprises the timing advance command; and receive a message from the user equipment, wherein a first uplink channel timing adjustment based on the timing advance command was applied to a transmission of the message at the user equipment by compensating for the additional time offset applied for transmitting the random access channel preamble.

According to another aspect, there is provided an apparatus comprising: means for receiving a random access channel preamble from a user equipment, wherein an additional time offset was applied to a transmission time of the random access channel preamble at the user equipment, wherein the additional time offset is different from timing corresponding to downlink channel timing adjustment; means for determining a timing advance command for the user equipment based on the random access channel preamble; means for transmitting, to the user equipment, a random access response in response to receiving the random access channel preamble, wherein the random access response comprises the timing advance command; and means for receiving a message from the user equipment, wherein a first uplink channel timing adjustment based on the timing advance command was applied to a transmission of the message at the user equipment by compensating for the additional time offset applied for transmitting the random access channel preamble.

According to another aspect, there is provided a method comprising: receiving a random access channel preamble from a user equipment, wherein an additional time offset was applied to a transmission time of the random access channel preamble at the user equipment, wherein the additional time offset is different from timing corresponding to downlink channel timing adjustment; determining a timing advance command for the user equipment based on the random access channel preamble; transmitting, to the user equipment, a random access response in response to receiving the random access channel preamble, wherein the random access response comprises the timing advance command; and receiving a message from the user equipment, wherein a first uplink channel timing adjustment based on the timing advance command was applied to a transmission of the message at the user equipment by compensating for the additional time offset applied for transmitting the random access channel preamble.

According to another aspect, there is provided a computer program comprising instructions which, when executed by an apparatus, cause the apparatus to perform at least the following: receiving a random access channel preamble from a user equipment, wherein an additional time offset was applied to a transmission time of the random access channel preamble at the user equipment, wherein the additional time offset is different from timing corresponding to downlink channel timing adjustment; determining a timing advance command for the user equipment based on the random access channel preamble; transmitting, to the user equipment, a random access response in response to receiving the random access channel preamble, wherein the random access response comprises the timing advance command; and receiving a message from the user equipment, wherein a first uplink channel timing adjustment based on the timing advance command was applied to a transmission of the message at the user equipment by compensating for the additional time offset applied for transmitting the random access channel preamble.

According to another aspect, there is provided a computer readable medium comprising program instructions which, when executed by an apparatus, cause the apparatus to perform at least the following: receiving a random access channel preamble from a user equipment, wherein an additional time offset was applied to a transmission time of the random access channel preamble at the user equipment, wherein the additional time offset is different from timing corresponding to downlink channel timing adjustment; determining a timing advance command for the user equipment based on the random access channel preamble; transmitting, to the user equipment, a random access response in response to receiving the random access channel preamble, wherein the random access response comprises the timing advance command; and receiving a message from the user equipment, wherein a first uplink channel timing adjustment based on the timing advance command was applied to a transmission of the message at the user equipment by compensating for the additional time offset applied for transmitting the random access channel preamble.

According to another aspect, there is provided a non-transitory computer readable medium comprising program instructions which, when executed by an apparatus, cause the apparatus to perform at least the following: receiving a random access channel preamble from a user equipment, wherein an additional time offset was applied to a transmission time of the random access channel preamble at the user equipment, wherein the additional time offset is different from timing corresponding to downlink channel timing adjustment; determining a timing advance command for the user equipment based on the random access channel preamble; transmitting, to the user equipment, a random access response in response to receiving the random access channel preamble, wherein the random access response comprises the timing advance command; and receiving a message from the user equipment, wherein a first uplink channel timing adjustment based on the timing advance command was applied to a transmission of the message at the user equipment by compensating for the additional time offset applied for transmitting the random access channel preamble.

### LIST OF DRAWINGS

In the following, various example embodiments will be described in greater detail with reference to the accompanying drawings, in which

FIG. 1 illustrates an example of a wireless communication network;

FIG. 2A and FIG. 2B illustrate timing advance;

FIG. 3 illustrates a random access response interception scenario;

FIG. 4A and FIG. 4B illustrate an example of an additional time offset;

FIG. 5A illustrates a random access response interception scenario;

FIG. 5B illustrates a random access response interception scenario;

FIG. 5C illustrates a random access response interception scenario;

FIG. 6 illustrates a flow chart;

FIG. 7 illustrates a flow chart;

FIG. 8 illustrates a flow chart;

FIG. 9 illustrates a flow chart;

FIG. 10 illustrates a flow chart;

FIG. 11 illustrates a flow chart;

FIG. 12 illustrates a flow chart;

FIG. 13 illustrates a flow chart;

FIG. 14 illustrates a flow chart;

FIG. 15 illustrates a signal flow diagram;

FIG. 16 illustrates an example of possible motion patterns caused by the additional time offset;

FIG. 17 illustrates an example of an apparatus; and

FIG. 18 illustrates an example of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Some example embodiments described herein may be implemented in a wireless communication network comprising a radio access network based on one or more of the following radio access technologies: Global System for Mobile Communications (GSM) or any other second generation radio access technology, Universal Mobile Telecommunication System (UMTS, 3G) based on basic wideband-code division multiple access (W-CDMA), high-speed packet access (HSPA), Long Term Evolution (LTE), LTE-Advanced, fourth generation (4G), fifth generation (5G), 5G new radio (NR), 5G-Advanced (i.e., 3GPP NR Rel-18 and beyond), or sixth generation (6G). Some examples of radio access networks include the universal mobile telecommunications system (UMTS) radio access network (UTRAN), the Evolved Universal Terrestrial Radio Access network (E-UTRA), or the next generation radio access network (NG-RAN). The wireless communication network may further comprise a core network, and some example embodiments may also be applied to network functions of the core network.

It should be noted that the embodiments are not restricted to the wireless communication network given as an example, but a person skilled in the art may also apply the solution to other wireless communication networks or systems provided with necessary properties. For example, some example embodiments may also be applied to a communication system based on IEEE 802.11 specifications, or a communication system based on IEEE 802.15 specifications.

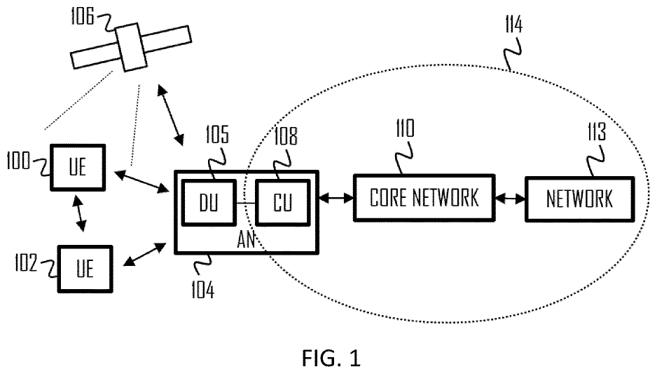

FIG. 1 depicts an example of a simplified wireless communication network showing some physical and logical entities. The connections shown in FIG. 1 may be physical connections or logical connections. It is apparent to a person skilled in the art that the wireless communication network may also comprise other physical and logical entities than those shown in FIG. 1.

The example embodiments described herein are not, however, restricted to the wireless communication network given as an example but a person skilled in the art may apply the embodiments described herein to other wireless communication networks provided with necessary properties.

The example wireless communication network shown in FIG. 1 includes an access network, such as a radio access network (RAN), and a core network 110.

FIG. 1 shows user equipment (UE) 100, 102 configured to be in a wireless connection on one or more communication channels in a radio cell with an access node (AN) 104 of an access network. The AN 104 may be an evolved Node B (abbreviated as eNB or eNodeB) or a next generation Node B (abbreviated as gNB or gNodeB), providing the radio cell. The wireless connection (e.g., radio link) from a UE to the access node 104 may be called uplink (UL) or reverse link, and the wireless connection (e.g., radio link) from the access node to the UE may be called downlink (DL) or forward link. UE 100 may also communicate directly with UE 102, and vice versa, via a wireless connection generally referred to as a sidelink (SL). It should be appreciated that the access node 104 or its functionalities may be implemented by using any node, host, server or access point etc. entity suitable for providing such functionalities.

The access network may comprise more than one access node, in which case the access nodes may also be configured to communicate with one another over links, wired or wireless. These links between access nodes may be used for sending and receiving control plane signaling and also for routing data from one access node to another access node.

The access node may comprise a computing device configured to control the radio resources of the access node. The access node may also be referred to as a base station, a base transceiver station (BTS), an access point, a cell site, a radio access node or any other type of node capable of being in a wireless connection with a UE (e.g., UEs 100, 102). The access node may include or be coupled to transceivers. From the transceivers of the access node, a connection may be provided to an antenna unit that establishes bi-directional radio links to UEs 100, 102. The antenna unit may comprise an antenna or antenna element, or a plurality of antennas or antenna elements.

The access node 104 may further be connected to a core network (CN) 110. The core network 110 may comprise an evolved packet core (EPC) network and/or a 5th generation core network (5GC). The EPC may comprise network entities, such as a serving gateway (S-GW for routing and forwarding data packets), a packet data network gateway (P-GW) for providing connectivity of UEs to external packet data networks, and a mobility management entity (MME). The 5GC may comprise network functions, such as a user plane function (UPF), an access and mobility management function (AMF), and a location management function (LMF).

The core network 110 may also be able to communicate with one or more external networks 113, such as a public switched telephone network or the Internet, or utilize services provided by them. For example, in 5G wireless communication networks, the UPF of the core network 110 may be configured to communicate with an external data network via an N6 interface. In LTE wireless communication networks, the P-GW of the core network 110 may be configured to communicate with an external data network.

The illustrated UE 100, 102 is one type of an apparatus to which resources on the air interface may be allocated and assigned. The UE 100, 102 may also be called a wireless communication device, a subscriber unit, a mobile station, a remote terminal, an access terminal, a user terminal, a terminal device, or a user device just to mention but a few names. The UE may be a computing device operating with or without a subscriber identification module (SIM), including, but not limited to, the following types of computing devices: a mobile phone, a smartphone, a personal digital assistant (PDA), a handset, a computing device comprising a wireless modem (e.g., an alarm or measurement device, etc.), a laptop computer, a desktop computer, a tablet, a game console, a notebook, a multimedia device, a reduced capability (RedCap) device, a wearable device (e.g., a watch, earphones or eyeglasses) with radio parts, a sensor comprising a wireless modem, or any computing device comprising a wireless modem integrated in a vehicle.

It should be appreciated that a UE may also be a nearly exclusive uplink-only device, of which an example may be a camera or video camera loading images or video clips to a network. A UE may also be a device having capability to operate in an Internet of Things (IoT) network, which is a scenario in which objects may be provided with the ability to transfer data over a network without requiring human-to-human or human-to-computer interaction. The UE may also utilize cloud. In some applications, the computation may be carried out in the cloud or in another UE.

The wireless communication network may also be able to support the usage of cloud services, for example at least part of core network operations may be carried out as a cloud service (this is depicted in FIG. 1 by “cloud” 114). The communication system may also comprise a central control entity, or the like, providing facilities for wireless communication networks of different operators to cooperate for example in spectrum sharing.

5G enables using multiple input-multiple output (MIMO) antennas in the access node 104 and/or the UE 100, 102, many more base stations or access nodes than an LTE network (a so-called small cell concept), including macro sites operating in co-operation with smaller stations and employing a variety of radio technologies depending on service needs, use cases and/or spectrum available. 5G wireless communication networks may support a wide range of use cases and related applications including video streaming, augmented reality, different ways of data sharing and various forms of machine type applications, such as (massive) machine-type communications (mMTC), including vehicular safety, different sensors and real-time control.

In 5G wireless communication networks, access nodes and/or UEs may have multiple radio interfaces, namely below 6 GHz, cmWave and mmWave, and also being integrable with existing legacy radio access technologies, such as the LTE. Integration with the LTE may be implemented, for example, as a system, where macro coverage may be provided by the LTE, and 5G radio interface access may come from small cells by aggregation to the LTE. In other words, a 5G wireless communication network may support both inter-RAT operability (such as LTE-5G) and inter-RI operability (inter-radio interface operability, such as below 6 GHZ-cmWave-mmWave). One of the concepts considered to be used in 5G wireless communication networks may be network slicing, in which multiple independent and dedicated virtual sub-networks (network instances) may be created within the substantially same infrastructure to run services that have different requirements on latency, reliability, throughput and mobility.

In some example embodiments, an access node (e.g., access node 104) may comprise: a radio unit (RU) comprising a radio transceiver (TRX), i.e., a transmitter (Tx) and a receiver (Rx); one or more distributed units (DUs) 105 that may be used for the so-called Layer 1 (L1) processing and real-time Layer 2 (L2) processing; and a central unit (CU) 108 (also known as a centralized unit) that may be used for non-real-time L2 and Layer 3 (L3) processing. The CU 108 may be connected to the one or more DUs 105 for example via an F1 interface. Such an embodiment of the access node may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU 108 may be a logical node hosting radio resource control (RRC), service data adaptation protocol (SDAP) and/or packet data convergence protocol (PDCP), of the NR protocol stack for an access node. The DU 105 may be a logical node hosting radio link control (RLC), medium access control (MAC) and/or physical (PHY) layers of the NR protocol stack for the access node. The operations of the DU may be at least partly controlled by the CU. It should also be understood that the distribution of functions between DU 105 and CU 108 may vary depending on implementation. The CU may comprise a control plane (CU-CP), which may be a logical node hosting the RRC and the control plane part of the PDCP protocol of the NR protocol stack for the access node. The CU may further comprise a user plane (CU-UP), which may be a logical node hosting the user plane part of the PDCP protocol and the SDAP protocol of the CU for the access node.

Cloud computing systems may also be used to provide the CU 108 and/or DU 105. A CU provided by a cloud computing system may be referred to as a virtualized CU (vCU). In addition to the vCU, there may also be a virtualized DU (vDU) provided by a cloud computing system. Furthermore, there may also be a combination, where the DU may be implemented on so-called bare metal solutions, for example application-specific integrated circuit (ASIC) or customer-specific standard product (CSSP) system-on-a-chip (SoC).

Edge cloud may be brought into the access network (e.g., RAN) by utilizing network function virtualization (NFV) and software defined networking (SDN). Using edge cloud may mean access node operations to be carried out, at least partly, in a computing system operationally coupled to a remote radio head (RRH) or a radio unit (RU) of an access node. It is also possible that access node operations may be performed on a distributed computing system or a cloud computing system located at the access node. Application of cloud RAN architecture enables RAN real-time functions being carried out at the access network (e.g., in a DU 105) and non-real-time functions being carried out in a centralized manner (e.g., in a CU 108).

It should also be understood that the distribution of functions between core network operations and access node operations may differ in future wireless communication networks compared to that of the LTE or 5G, or even be non-existent. Some other technology advancements that may be used include big data and all-IP, which may change the way wireless communication networks are being constructed and managed. 5G (or new radio, NR) wireless communication networks may support multiple hierarchies, where multi-access edge computing (MEC) servers may be placed between the core network 110 and the access node 104. It should be appreciated that MEC may be applied in LTE wireless communication networks as well.

A 5G wireless communication network (“5G network”) may also comprise a non-terrestrial communication network, such as a satellite communication network, to enhance or complement the coverage of the 5G radio access network. For example, satellite communication may support the transfer of data between the 5G radio access network and the core network, enabling more extensive network coverage. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). A given satellite 106 in the mega-constellation may cover several satellite-enabled network entities that create on-ground cells. The on-ground cells may be created through an on-ground relay access node or by an access node 104 located on-ground or in a satellite.

It is obvious for a person skilled in the art that the access node 104 depicted in FIG. 1 is just an example of a part of an access network (e.g., a radio access network) and in practice, the access network may comprise a plurality of access nodes, the UEs 100, 102 may have access to a plurality of radio cells, and the access network may also comprise other apparatuses, such as physical layer relay access nodes or other entities. At least one of the access nodes may be a Home eNodeB or a Home gNodeB. A Home gNodeB or a Home eNodeB is a type of access node that may be used to provide indoor coverage inside a home, office, or other indoor environment.

Additionally, in a geographical area of an access network (e.g., a radio access network), a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) of FIG. 1 may provide any kind of these cells. A cellular radio network may be implemented as a multilayer access networks including several kinds of radio cells. In multilayer access networks, one access node may provide one kind of a radio cell or radio cells, and thus a plurality of access nodes may be needed to provide such a multilayer access network.

For fulfilling the need for improving performance of access networks, the concept of “plug-and-play” access nodes may be introduced. An access network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's access network, may aggregate traffic from a large number of Home eNodeBs or Home gNodeBs back to a core network of the operator.

Due to the propagation delay associated with wireless communication, a UE 100, 102 may need proper uplink channel timing adjustment to make sure that its uplink transmission is correctly received by a RAN node 104 (base station). For example, a UE that is far away from the RAN node may encounter a larger propagation delay than another UE that is closer to the RAN node.

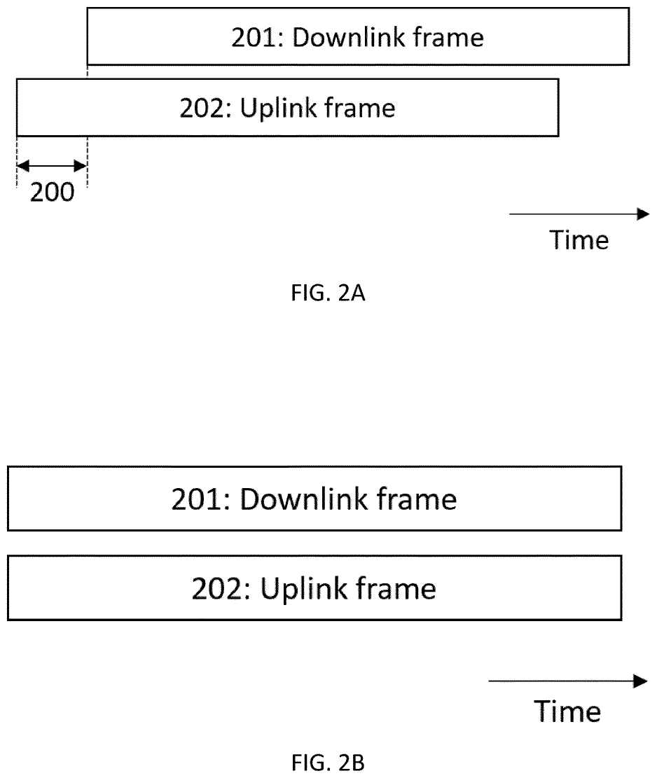

FIG. 2A and FIG. 2B illustrate the concept of timing advance.

In FIG. 2A, there is no synchronization between the downlink (DL) frame 201 and the uplink (UL) frame 202.

In FIG. 2B, synchronization between the DL frame 201 and UL frame 202 is achieved by applying a timing advance (TA) 200 to the UL frame 202. The timing advance 200 applied by the UE may also be referred to as uplink channel timing adjustment. Downlink, uplink, and sidelink transmissions may be organized into radio frames with a duration of 10 ms, wherein a given radio frame comprises ten subframes of 1 ms.

The timing advance 200 is a negative offset at the UE between the start of the received DL frame 201 and the transmitted UL frame 202. The timing advance can be used to take into account the propagation delay between the UE and the RAN node. This offset may be used to ensure that the DL and UL frames are synchronized at the RAN node (in the time domain). Thus, the UE may adjust its uplink transmissions by sending uplink symbols in advance according to the amount of time defined by the timing advance 200. In other words, uplink frame number i for transmission from the UE starts before the start of the corresponding downlink frame at the UE according to the timing advance 200 calculated by the UE.

In the current 5G NR specifications, TA adjustment consists of two parts: 1) based on the network signaling of TA adjustment (e.g., a timing advance command) to the UE, and 2) autonomous UL transmit timing adjustment by the UE. In other words, once the UE has been assigned a TA value by the network (e.g., via a timing advance command), the UE may track its DL timing and adjust the UL transmit timing to be within a set threshold.

Currently, there are two ways to deliver TA adjustment to a UE: 1) via a random access response (RAR) as part of a random access procedure, or 2) via MAC control element (MAC CE).

For example, the random access procedure may be needed in the following cases: initial access from RRC idle state, RRC connection re-establishment procedure, handover procedure, downlink or uplink data arrival during RRC connected (when uplink synchronization status is “non-synchronized”, transition from RRC inactive state (e.g., in 5G), to establish time alignment at secondary cell (SCell) addition (e.g., in 5G), request for other system information (SI) (e.g., in 5G), and/or beam failure recovery (e.g., in 5G).

Whether the random access procedure is a contention based random access (CBRA) or contention free random access (CFRA) has no impact on the content of the timing advance command.

In the first option (i.e., delivering TA adjustment via RAR), the UE may transmit a random access channel (RACH) preamble to the RAN node after downlink channel synchronization is achieved based on synchronization signals, such as a primary synchronization signal (PSS) and a secondary synchronization signal (SSS), received from the RAN node. The RACH preamble is transmitted without timing advance. The RACH preamble may also be referred to as Msg1. The RACH preamble may be transmitted at time T_{X}=T_{PRACH}, Where T_{PRACH} can be calculated based on downlink channel timing synchronization. Then, the RAN node may calculate the needed timing advance (TA) based on the guard period and preamble type of the RACH preamble, and signal this value to the UE via a random access response, which comprises a timing advance command. The random access response may also be referred to as Msg2. The UE may use the TA index value from the timing advance command for uplink channel timing adjustment. The UE may apply the timing advance value that it extracts from the RAR to synchronize one or more of its following uplink transmissions. In case the UE receives a timing advance update (e.g., MAC CE) following the random access procedure, the UE may apply the timing advance value that it extracts from the MAC CE for its next uplink transmissions.

For example, the timing advance 200 may be calculated as:

$${T}_{T A} = ( {N}_{T A} + {N}_{T A , offset} ) {T}_{c}$$

T_{TA} is the calculated timing advance between uplink and downlink to be applied by the UE.
N_{TA} is a timing advance value provided by the RAN node (e.g., provided in the timing advance command).
N_{TA,offset} is a fixed offset value that may vary according to different frequency bands and subcarrier spacing.
T_{c} is a basic time unit, for example 0.509 ns in 5G.

For example, the RAN node may calculate the timing advance value as:

$${N}_{T A} = \frac{{T}_{A} * 16 * 64}{{2}^{μ}}$$

T_{A} is an index value indicating an adjustment step size. In 5G, the RAR T_{A}=0, 1, 2 . . . , 3848.
μ is a constant related to subcarrier spacing (SCS).

In the second option (i.e., delivering TA adjustment via MAC CE), TA estimation is done at the RAN node based on one or more reference signals, such as a demodulation reference signal (DMRS) or sounding reference signal (SRS) transmitted from the UE. As mentioned above, the UE adjusts UL transmission timing based on the RAR during the random access procedure. Once the initial attach is complete, the UE may adjust UL transmission timing based on the MAC CE timing advance.

For example, the RAN node may calculate the updated timing advance value for the MAC CE timing advance command as:

$${N}_{TA \_ new} = {N}_{TA \_ old} + \frac{( {T}_{A} - 31 ) * 16 * 64}{{2}^{μ}}$$

N_{TA_old} refers to the previous timing advance value provided in the RAR or in a previous MAC CE.

In 5G, the MAC CE T_{A}=0, 1, . . . , 63. This in turn gives an ability to compensate ±32T_{A}. For 5G, ±32T_{A} corresponds to a distance of ±39.04 meters.

For example, 1 T_{A}=16T_{c}=8,144 ns may correspond to 2.44 meters in round trip distance, or 1.22 meters one way.

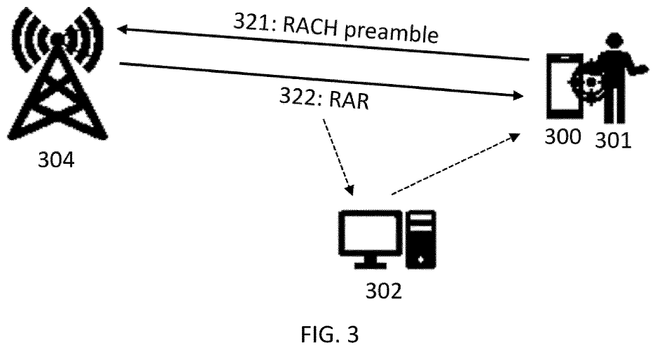

FIG. 3 illustrates a RAR interception scenario. FIG. 3 may be understood to depict a part of the wireless communication network of FIG. 1, but with greater accuracy with respect to the RAR interception scenario. For example, the RAN node 304 of FIG. 3 may correspond to the access node 104 of FIG. 1, and the UE 300 of FIG. 3 may correspond to UE 100 of FIG. 1.

After the RAN node 304 receives the RACH preamble 321 from the UE 300, the timing advance command in the RAR 322 is provided in a plain form, since cyphering (encryption) cannot be applied at this stage. Thus, as illustrated in FIG. 3, there is a security threat in that a radio interface eavesdropping device 302 may intercept the RAR 322 including the timing advance command, and use this information against the UE 300 or the user 301 of the UE 300. For example, the timing advance can be used for positioning the UE 300, for example by using an extended cell identity (E-CID) technique, since the timing advance is proportional to the distance between the UE 300 and the antenna of the RAN node 304. This can be considered as a security breach, for example, in sensitive network applications, such as public safety, government, military, security, or in 5G private network concept. Thus, there is a need for a solution, which can prevent the security breach exploitation described above.

Some example embodiments are described below using principles and terminology of 5G radio access technology without limiting the example embodiments to 5G radio access technology, however. For example, some example embodiments may also be applied to LTE.

Some example embodiments may address the above problem by adding a user-specific time offset, denoted as T_{USER}, at a UE before the RACH preamble is sent. The user-specific time offset may be considered as an additional time offset different from timing corresponding to downlink channel timing adjustment.

The additional time offset T_{USER} may be a positive or negative offset, and it may be stored in the internal memory of the UE or defined by a user. The network (e.g., RAN node) may not be aware of the application of this additional time offset at the UE, which means that the timing advance value provided in the RAR also covers the additional time offset applied at the UE. In other words, the RAN node is not aware of the additional time offset, when calculating the timing advance value for the UE. Thus, the RAN node may execute a standard random access procedure.

The additional time offset T_{USER} may be applied to the transmission time T_{PRACH} of the RACH preamble such that the RACH preamble is transmitted at time T_{X}=T_{PRACH}+T_{USER}. As mentioned above, T_{PRACH} can be calculated based on standard downlink channel timing synchronization.

At the UE, the received TA value from the RAR can be corrected by compensating for the additional time offset T_{USER}. For example, a corresponding index value N_{USER} may be calculated as:

$${N}_{U S E R} = \frac{{T}_{U S E R}}{1 {T}_{c}}$$

Then, N_{USER} may be added with an opposite sign to determine the correct timing advance (i.e., uplink channel timing adjustment):

$${T}_{T A} = ( {N}_{T A} + {N}_{T A , offset} - {N}_{USER} ) {T}_{c}$$

By compensating for the additional time offset as described above, proper uplink channel timing adjustment can be provided at the UE.

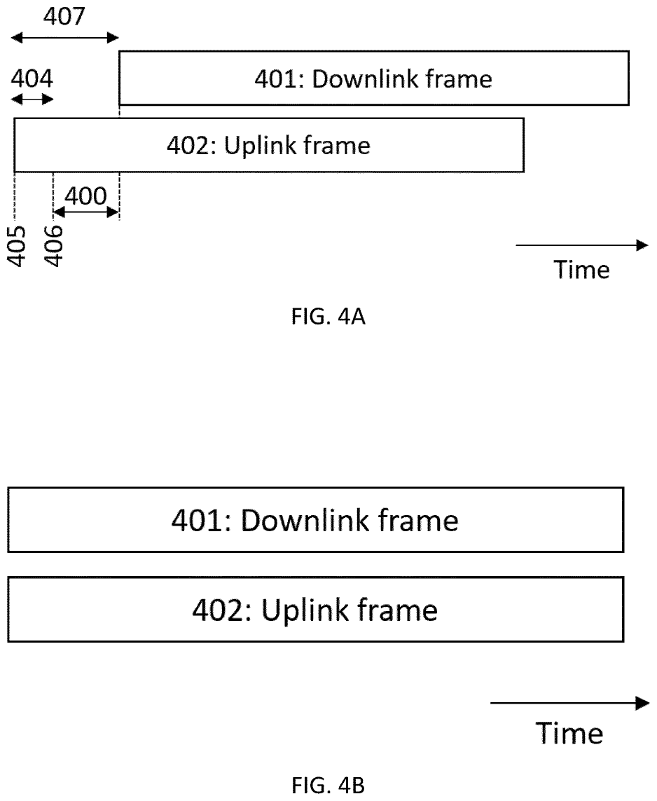

FIG. 4A and FIG. 4B illustrate an example of the additional time offset T_{USER} 404.

In FIG. 4A, there is no synchronization between the downlink frame 401 and the uplink frame 402, but the UE applies an additional time offset 404 (i.e., T_{USER}) to the transmission time of the uplink frame 402 (i.e., RACH preamble). In this example, as a result of applying the additional time offset, the RACH preamble is transmitted at time 405, whereas without the additional time offset the RACH preamble would be transmitted at time 406. In other words, in this example, the additional time offset is kind of like a timing advance applied to the transmission of the RACH preamble. Without the additional time offset, no timing advance would be applied to the transmission of the RACH preamble, since the RAN node has not yet calculated the timing advance value needed for synchronizing the downlink frame 401 and the uplink frame 402.

In FIG. 4B, after the RAN node has calculated the timing advance value based on the RACH preamble and provided the timing advance value to the UE in a timing advance command, the UE applies an uplink channel timing adjustment to synchronize the downlink frame 401 and the uplink frame 402. The UE determines the uplink channel timing adjustment based on the timing advance command by compensating for the additional time offset 404 applied for transmitting the RACH preamble. Since the RAN node is not aware of the additional time offset 404 applied at the UE, the timing advance command would result in an incorrect timing advance 407. However, the UE may determine the correct timing advance 400 by compensating for the additional time offset 404, thus ensuring correct uplink channel timing adjustment.

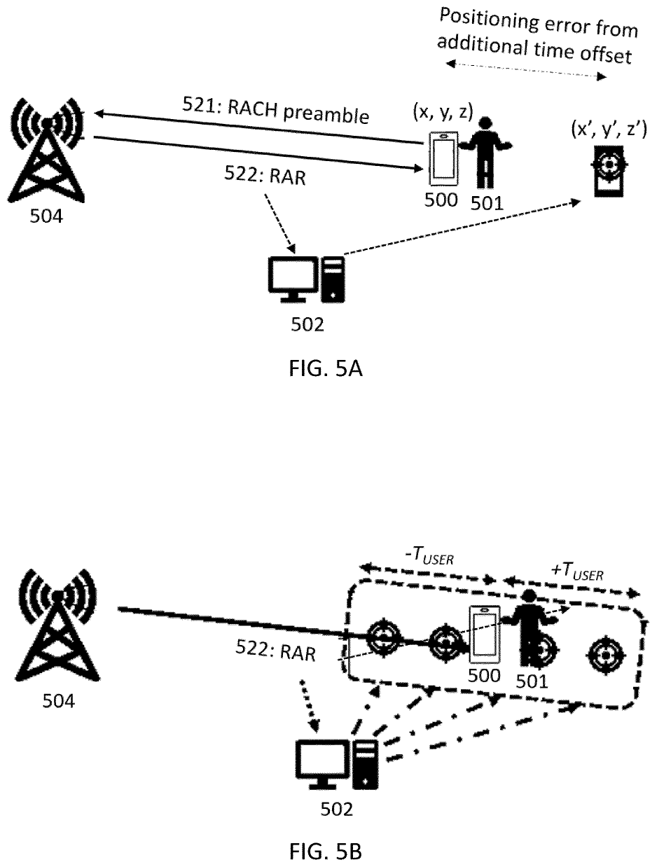

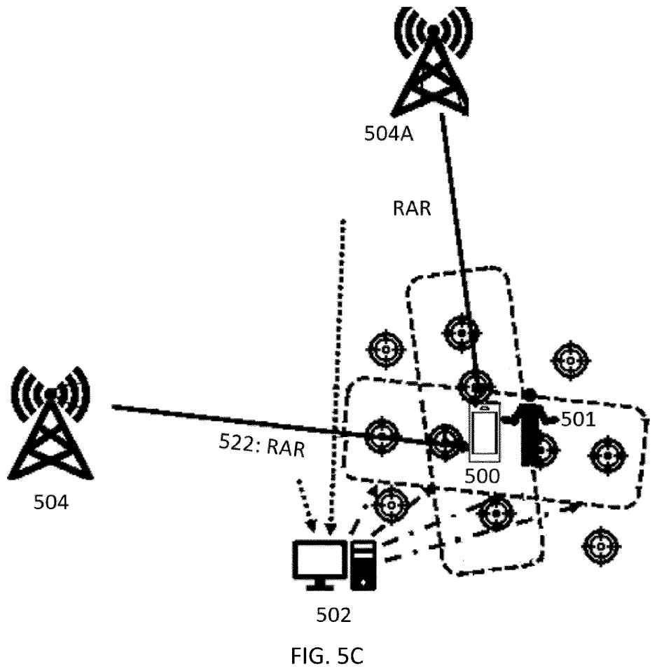

FIG. 5A illustrates an example of a RAR interception scenario, wherein an example embodiment is applied. FIG. 5A may be understood to depict a part of the wireless communication network of FIG. 1, but with greater accuracy with respect to the RAR interception scenario. For example, the RAN node 504 of FIG. 5A may correspond to the access node 104 of FIG. 1, and the UE 500 of FIG. 5A may correspond to UE 100 of FIG. 1.

In FIG. 5A, a UE 500 at true position (x, y, z) applies an additional time offset (i.e., T_{USER}) to a transmission time of a RACH preamble 521, and the UE 500 transmits the RACH preamble 521 to a RAN node 504 according to the transmission time applied with the additional time offset.

The RAN node 504 executes a standard random access procedure, i.e., determines a timing advance value for the UE 500 based on the RACH preamble 521 (without being aware of the additional time offset), and the RAN node 504 transmits a timing advance command to the UE 500 in a random access response 522 in a plain form, since cyphering (encryption) cannot be applied at this stage.

A radio interface eavesdropping device 502 may intercept the RAR 522 including the timing advance command, and use this information to estimate the position of the UE 500 or the user 501 of the UE 500. However, since the eavesdropper 502 is not aware of the additional time offset applied at the UE 500, the eavesdropper cannot determine the true position (x, y, z) of the UE 500. By applying the additional time offset, the false position (x′, y′, z′) derived by the eavesdropper 502 from the TA value (e.g., in E-CID) can be seemingly moved away from the true position (x, y, z) of the UE 500. Thus, if the RAR 522 with the TA value in plain form has been intercepted, a false position (x′, y′, z′) can be provided to the unauthorized recipient 502, instead of the true position (x, y, z).

The UE 500 determines an uplink channel timing adjustment based on the timing advance command by compensating for the additional time offset applied for transmitting the RACH preamble. The UE 500 may then continue the connection establishment procedure. Once the UE authentication is confirmed, cyphering (encryption) can be applied for other uplink and downlink transmissions.

Thus, correct uplink channel timing adjustment is ensured, while also mitigating the threat from the eavesdropper 502. In this way, the problem of providing the TA value in plain form in the RAR 522 may be resolved.

FIG. 5B illustrates an example of dilution of RAR TA precision, when one RAN node 504 is used as a reference. FIG. 5B illustrates an example of the possible position estimates of the UE 500, which can be derived from RAR TA unauthorized interception from one RAN node 504 as reference. The UE 500 may use different T_{USER} settings for new RACH preambles, or the pattern of T_{USER} may be standardized.

FIG. 5C illustrates an example of dilution of RAR TA precision, when two RAN nodes 504, 504A are used as a reference. FIG. 5C illustrates an example of the possible position estimates of the UE 500, which can be derived from RAR TA unauthorized interception from two RAN nodes 504, 504A as references. As can be seen in FIG. 5C, the number of potential UE positions is much higher compared to FIG. 5B, if intercepted TA values from two RAN nodes 504, 504A used as references are evaluated jointly.

In FIG. 5B and FIG. 5C, the beam size of the RAN node 504, 504A may narrow the number of potential UE positions. However, the beam may not be smaller than 7-14 degrees, therefore offering sufficient protection, as such positioning cannot be accurate.

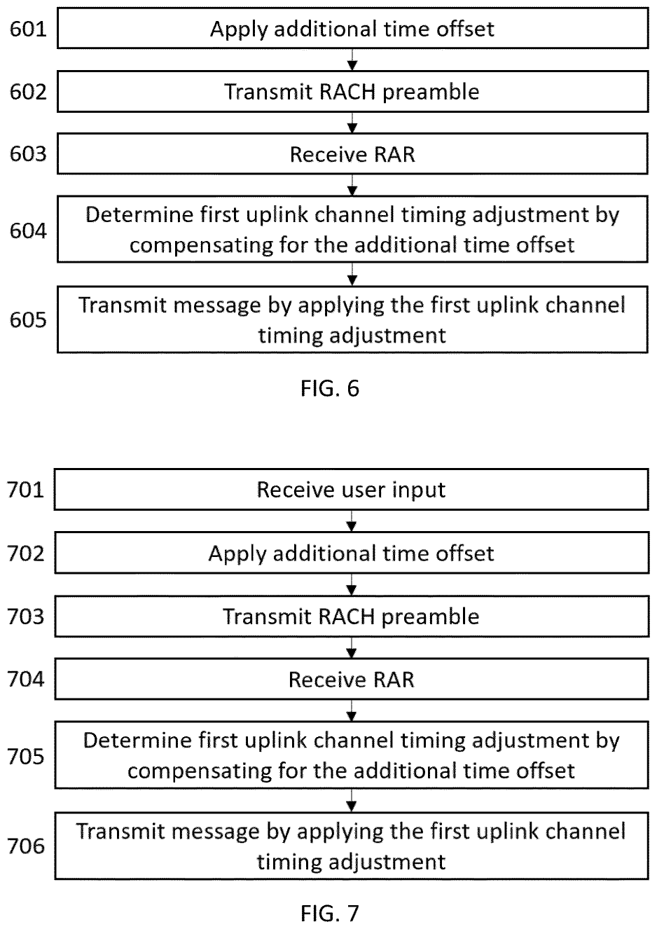

FIG. 6 illustrates a flow chart according to an example embodiment of a method performed by an apparatus 1700. For example, the apparatus 1700 may be, or comprise, or be comprised in, a user equipment 100, 500.

Referring to FIG. 6, in block 601, the apparatus applies an additional time offset to a transmission time of a random access channel preamble, wherein the additional time offset is different from timing corresponding to downlink channel timing adjustment. The additional time offset refers to T_{USER} described above.

It should be noted that before the RACH preamble is transmitted, it may be synchronized with the downlink channel (e.g., based on PSS and/or SSS). However, the additional time offset is different from this synchronization.

In block 602, the apparatus transmits, to a radio access network node 104, 504, the random access channel preamble according to the transmission time applied with the additional time offset.

In block 603, the apparatus receives, from the radio access network node, a random access response in response to transmitting the random access channel preamble, wherein the random access response comprises a timing advance command.

In block 604, the apparatus determines a first uplink channel timing adjustment based on the timing advance command by compensating for the additional time offset applied for transmitting the random access channel preamble.

For example, as described above, the first uplink channel timing adjustment may be determined as:

$${T}_{T A} = ( {N}_{T A} + {N}_{T A , offset} - {N}_{USER} ) {T}_{c}$$

In block 605, the apparatus transmits, to the radio access network node, a message by applying the first uplink channel timing adjustment compensated for the additional time offset. For example, the message may be an RRC setup request message (i.e., Msg3 of the random access procedure) or any other message.

FIG. 7 illustrates a flow chart according to an example embodiment of a method performed by an apparatus 1700. For example, the apparatus 1700 may be, or comprise, or be comprised in, a user equipment 100, 500.

Referring to FIG. 7, in block 701, the apparatus receives a user input indicating an additional time offset. The additional time offset refers to T_{USER} described above.

For example, a security, safety, or privacy-oriented user 501 may feel more comfortable, if the position of the UE 500 derived from the TA value will be seemingly moved away, for example, by a distance of 30 meters (i.e., approximately 0.1 μs additional time offset). 30 meters also corresponds to rounded 25 T_{A}, i.e., one way. Thus, the user 501 may set a distance offset (e.g., 30 meters), which may be converted to a corresponding time domain value, or expressed in TA steps, at the UE 500 for applying the additional time offset corresponding to the distance offset desired by the user.

In block 702, the apparatus applies the additional time offset to a transmission time of a random access channel preamble, wherein the additional time offset is different from timing corresponding to downlink channel timing adjustment.

In block 703, the apparatus transmits, to a radio access network node 104, 504, the random access channel preamble according to the transmission time applied with the additional time offset.

In block 704, the apparatus receives, from the radio access network node, a random access response in response to transmitting the random access channel preamble, wherein the random access response comprises a timing advance command.

Since the RAN node is not aware of the additional time offset, the RAN node may interpret the RACH preamble as being originated from a distance extended by the distance offset (e.g., 30 meters) set by the user. Thus, the TA value provided in the RAR timing advance command may include the additional time offset (e.g., 25 T_{A}). In other words, the TA value provided in the RAR is incorrect, and its interception cannot harm the apparatus (UE) or its user.

In block 705, the apparatus determines a first uplink channel timing adjustment based on the timing advance command by compensating for the additional time offset applied for transmitting the random access channel preamble.

For example, in case the additional time offset is 25 T_{A}, then the apparatus may use N_{USER}=25 T_{A} in the following equation for determining the proper uplink channel timing adjustment:

$${T}_{T A} = ( {N}_{T A} + {N}_{T A , offset} - {N}_{USER} ) {T}_{c}$$

In block 706, the apparatus transmits, to the radio access network node, a message by applying the first uplink channel timing adjustment compensated for the additional time offset. For example, the message may be an RRC setup request message (i.e., Msg3 of the random access procedure) or any other message.

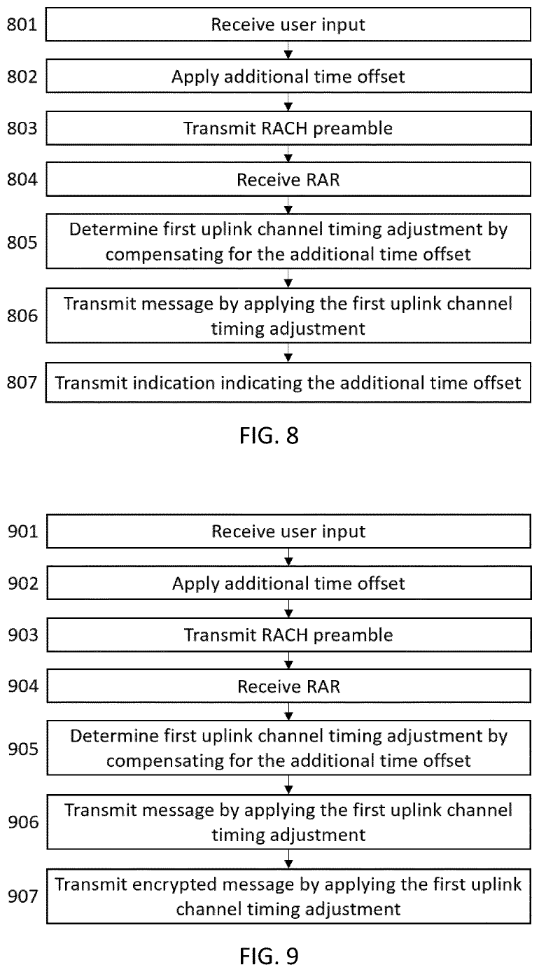

FIG. 8 illustrates a flow chart according to an example embodiment of a method performed by an apparatus 1700. For example, the apparatus 1700 may be, or comprise, or be comprised in, a user equipment 100, 500.

Referring to FIG. 8, in block 801, the apparatus may receive a user input indicating an additional time offset. Alternatively, the additional time offset may be pre-defined or selected by the apparatus. The additional time offset refers to T_{USER} described above.

In block 802, the apparatus applies the additional time offset to a transmission time of a random access channel preamble, wherein the additional time offset is different from timing corresponding to downlink channel timing adjustment.

In block 803, the apparatus transmits, to a radio access network node 104, 504, the random access channel preamble according to the transmission time applied with the additional time offset.

In block 804, the apparatus receives, from the radio access network node, a random access response in response to transmitting the random access channel preamble, wherein the random access response comprises a timing advance command.

In block 805, the apparatus determines a first uplink channel timing adjustment based on the timing advance command by compensating for the additional time offset applied for transmitting the random access channel preamble.

For example, as described above, the first uplink channel timing adjustment may be determined as:

$${T}_{T A} = ( {N}_{T A} + {N}_{T A , offset} - {N}_{USER} ) {T}_{c}$$

In block 806, the apparatus transmits, to the radio access network node, a message by applying the first uplink channel timing adjustment compensated for the additional time offset. For example, the message may be an RRC setup request message (i.e., Msg3 of the random access procedure) or any other message.

In block 807, the apparatus transmits, to the radio access network node, an indication indicating the additional time offset. The indication may be transmitted in an encrypted message in order to prevent an eavesdropper from learning the additional time offset applied by the apparatus.

For example, after cyphering (encryption) is applied, the apparatus may inform the radio access network node about the applied T_{USER} or N_{USER} value as part of UE capability information, and thus the radio access network node may become aware of the additional time offset applied at the apparatus. The radio access network node may then compensate for the additional time offset for example in TA-based positioning techniques (e.g., E-CID). In this case, the additional time offset may have no impact on legacy or emergency positioning techniques. For example, in case of legal or emergency connections or positioning, T_{USER} can be compensated at the RAN node. Also, based on the type of connection requested by the user, T_{USER} can also be compensated before the RACH preamble is transmitted.

FIG. 9 illustrates a flow chart according to an example embodiment of a method performed by an apparatus 1700. For example, the apparatus 1700 may be, or comprise, or be comprised in, a user equipment 100, 500.

Referring to FIG. 9, in block 901, the apparatus may receive a user input indicating an additional time offset. Alternatively, the additional time offset may be pre-defined or selected by the apparatus. The additional time offset refers to T_{USER} described above.

In block 902, the apparatus applies the additional time offset to a transmission time of a random access channel preamble, wherein the additional time offset is different from timing corresponding to downlink channel timing adjustment.

In block 903, the apparatus transmits, to a radio access network node 104, 504, the random access channel preamble according to the transmission time applied with the additional time offset.

In block 904, the apparatus receives, from the radio access network node, a random access response in response to transmitting the random access channel preamble, wherein the random access response comprises a timing advance command.

In block 905, the apparatus determines a first uplink channel timing adjustment based on the timing advance command by compensating for the additional time offset applied for transmitting the random access channel preamble.

For example, as described above, the first uplink channel timing adjustment may be determined as:

$${T}_{T A} = ( {N}_{T A} + {N}_{T A , offset} - {N}_{USER} ) {T}_{c}$$

In block 906, the apparatus transmits, to the radio access network node, a message by applying the first uplink channel timing adjustment compensated for the additional time offset. For example, the message may be an RRC setup request message (i.e., Msg3 of the random access procedure) or any other message.

In block 907, the apparatus transmits, to the radio access network node, an encrypted message by applying the first uplink channel timing adjustment.

In other words, after cyphering is applied, the apparatus may still use the same N_{USER} value. In this case, the radio access network node may be provided with purposefully incorrect TA data in order to strengthen the security, safety, and privacy. Since the network is not provided with correct TA data, this means that TA-based positioning techniques may be inaccurate. This may be beneficial, for example, in case the apparatus needs to establish a wireless connection in a less trusted standard (e.g., LTE), or when there is a risk that the network is compromised, or the TA data can be used against the user.

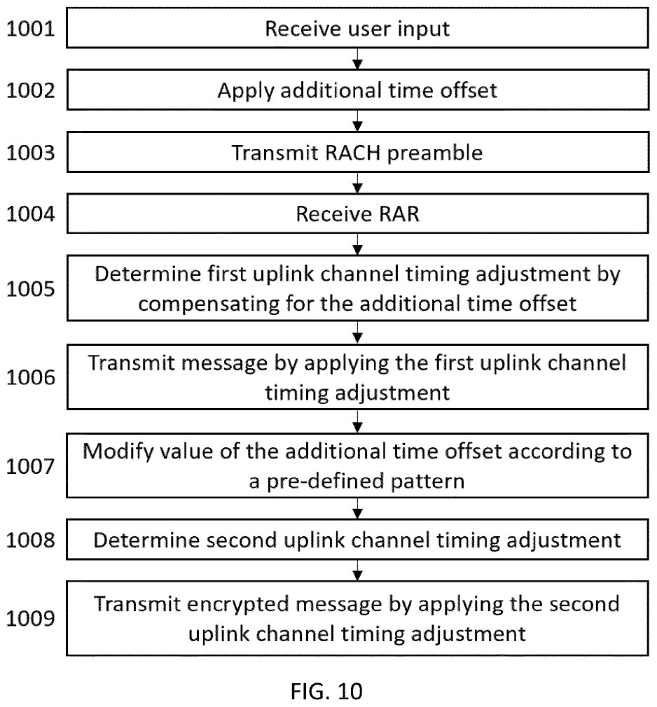

FIG. 10 illustrates a flow chart according to an example embodiment of a method performed by an apparatus 1700. For example, the apparatus 1700 may be, or comprise, or be comprised in, a user equipment 100, 500.

Referring to FIG. 10, in block 1001, the apparatus may receive a user input indicating an additional time offset. Alternatively, the additional time offset may be pre-defined or selected by the apparatus. The additional time offset refers to T_{USER} described above.

In block 1002, the apparatus applies the additional time offset to a transmission time of a random access channel preamble, wherein the additional time offset is different from timing corresponding to downlink channel timing adjustment.

In block 1003, the apparatus transmits, to a radio access network node 104, 504, the random access channel preamble according to the transmission time applied with the additional time offset.

In block 1004, the apparatus receives, from the radio access network node, a random access response in response to transmitting the random access channel preamble, wherein the random access response comprises a timing advance command.

In block 1005, the apparatus determines a first uplink channel timing adjustment based on the timing advance command by compensating for the additional time offset applied for transmitting the random access channel preamble.

For example, as described above, the first uplink channel timing adjustment may be determined as:

$${T}_{T A} = ( {N}_{T A} + {N}_{T A , offset} - {N}_{USER} ) {T}_{c}$$

In block 1006, the apparatus transmits, to the radio access network node, a message by applying the first uplink channel timing adjustment compensated for the additional time offset. For example, the message may be an RRC setup request message (i.e., Msg3 of the random access procedure) or any other message.

In block 1007, the apparatus modifies a value of the additional time offset according to a pre-defined pattern. For example, the pre-defined pattern may be selected from a plurality of pre-defined patterns.

In other words, after cyphering is applied, the apparatus may modify the T_{USER} Or N_{USER} value according to the pre-defined pattern. In this case, the radio access network node may be provided with purposefully incorrect data in order to strengthen the security, safety, and privacy.

For example, the pre-defined pattern may be constructed from initial T_{USER} values provided or requested by the user and following modifications of the initial T_{USER} value.

As a non-limiting example, the initial T_{USER} value may correspond to a distance offset of 30 meters, and, after cyphering is applied, the T_{USER} value may be decreased by 10% (3 meters) per 1 second according to the pre-defined pattern until T_{USER}=0. In this case, 10 MAC CE timing advance updates may be needed until T_{USER}=0.

The pattern may be different for different random access procedures, therefore making it more difficult for an eavesdropper to recognize the pattern.

In block 1008, the apparatus determines a second uplink channel timing adjustment based on the timing advance command or a timing advance update by compensating for the modified value of the additional time offset. For example, the timing advance update may be received in a MAC CE timing advance command following the random access procedure, as the apparatus may be moving and thus the TA may need to be updated.

In block 1009, the apparatus transmits, to the radio access network node, an encrypted message by applying the second uplink channel timing adjustment compensated for the modified value of the additional time offset.

For example, the encrypted message may comprise an indication indicating the pre-defined pattern used for modifying the value of the additional time offset. For example, after cyphering (encryption) is applied, the apparatus may inform the radio access network node about the additional time offset and/or the pre-defined pattern used by the apparatus as part of UE capability information, and thus the radio access network node may become aware of the additional time offset applied at the apparatus. The radio access network node may then compensate for the additional time offset for example in TA-based positioning techniques. In this case, the additional time offset may have no impact on legacy or emergency positioning techniques.

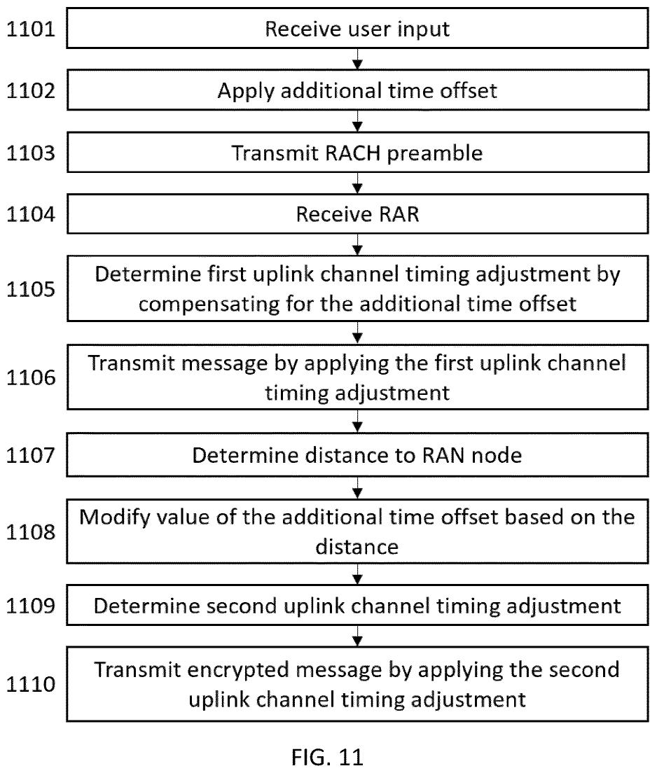

FIG. 11 illustrates a flow chart according to an example embodiment of a method performed by an apparatus 1700. For example, the apparatus 1700 may be, or comprise, or be comprised in, a user equipment 100, 500.

Referring to FIG. 11, in block 1101, the apparatus may receive a user input indicating an additional time offset. Alternatively, the additional time offset may be pre-defined or selected by the apparatus. The additional time offset refers to T_{USER} described above.

In block 1102, the apparatus applies the additional time offset to a transmission time of a random access channel preamble, wherein the additional time offset is different from timing corresponding to downlink channel timing adjustment.

In block 1103, the apparatus transmits, to a radio access network node 104, 504, the random access channel preamble according to the transmission time applied with the additional time offset.

In block 1104, the apparatus receives, from the radio access network node, a random access response in response to transmitting the random access channel preamble, wherein the random access response comprises a timing advance command.

In block 1105, the apparatus determines a first uplink channel timing adjustment based on the timing advance command by compensating for the additional time offset applied for transmitting the random access channel preamble.

For example, as described above, the first uplink channel timing adjustment may be determined as:

$${T}_{T A} = ( {N}_{T A} + {N}_{T A , offset} - {N}_{USER} ) {T}_{c}$$

In block 1106, the apparatus transmits, to the radio access network node, a message by applying the first uplink channel timing adjustment compensated for the additional time offset. For example, the message may be an RRC setup request message (i.e., Msg3 of the random access procedure) or any other message.

In block 1107, the apparatus determines, based on the timing advance command, a distance between the apparatus and the radio access network node.

In block 1108, the apparatus modifies a value of the additional time offset based on the distance between the apparatus and the radio access network

The maximum range of the RAN node (cell) may be limited by signal power, which needs to be above the minimal sensitivity level, and also by the maximum supported timing advance index value TA_{MAX} (e.g., 3848), which limits the cell operational range. However, based on signal power measurements, the apparatus (UE) cannot correctly assess proximity to the antenna of the RAN node, as the signal power level may depend on many factors. In this context, the apparatus (UE) may be at any distance to the antenna of the RAN node. Thus, if a positive time offset T_{USER} is added, it may happen that the RAN node recognizes the UE as being beyond TA_{MAX}, which would mean that the corresponding RACH preamble would not be processed. However, this may not be a problem, as the apparatus (UE) can repeat the random access procedure with a negative time offset T_{USER}.

However, once the RAR with the timing advance command is received, the apparatus may determine the distance to the RAN node based on the TA index value. Thus, based on the distance, the apparatus may apply an additional time offset T_{USER} value within the TA_{MAX} range for the subsequent communications in order to ensure that the additional time offset is within the operational range of the RAN node. For example, the additional time offset T_{USER} being between ±30 m (±0.1 μs) and ±3000 m (±10 μs) may be sufficient in the majority of security, safety, and privacy-oriented applications.

The modification may also be based on a pre-defined pattern, as described above with reference to FIG. 10. For example, the pre-defined pattern may be selected from a plurality of pre-defined patterns, in which case the pattern may be different for different random access procedures, thus making it more difficult for an eavesdropper to recognize the pattern.

In block 1109, the apparatus determines a second uplink channel timing adjustment based on the timing advance command or a timing advance update by compensating for the modified value of the additional time offset. For example, the timing advance update may be received in a MAC CE timing advance command following the random access procedure, as the apparatus may be moving.

In block 1110, the apparatus transmits, to the radio access network node, an encrypted message by applying the second uplink channel timing adjustment compensated for the modified value of the additional time offset.

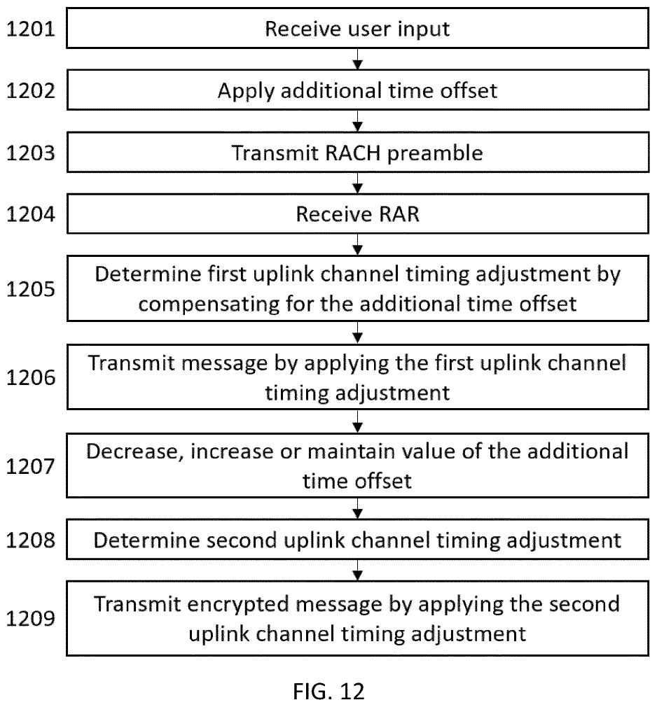

FIG. 12 illustrates a flow chart according to an example embodiment of a method performed by an apparatus 1700. For example, the apparatus 1700 may be, or comprise, or be comprised in, a user equipment 100, 500.

Referring to FIG. 12, in block 1201, the apparatus may receive a user input indicating an additional time offset. Alternatively, the additional time offset may be pre-defined or selected by the apparatus. The additional time offset refers to T_{USER} described above.

In block 1202, the apparatus applies the additional time offset to a transmission time of a random access channel preamble, wherein the additional time offset is different from timing corresponding to downlink channel timing adjustment.

In block 1203, the apparatus transmits, to a radio access network node 104, 504, the random access channel preamble according to the transmission time applied with the additional time offset.

In block 1204, the apparatus receives, from the radio access network node, a random access response in response to transmitting the random access channel preamble, wherein the random access response comprises a timing advance command.

In block 1205, the apparatus determines a first uplink channel timing adjustment based on the timing advance command by compensating for the additional time offset applied for transmitting the random access channel preamble.

For example, as described above, the first uplink channel timing adjustment may be determined as:

$${T}_{T A} = ( {N}_{T A} + {N}_{T A , offset} - {N}_{USER} ) {T}_{c}$$

In block 1206, the apparatus transmits, to the radio access network node, a message by applying the first uplink channel timing adjustment compensated for the additional time offset. For example, the message may be an RRC setup request message (i.e., Msg3 of the random access procedure) or any other message.

In block 1207, the apparatus decreases or increases or maintains a value of the additional time offset.

For example, after cyphering is applied, the apparatus may gradually decrease the N_{USER} value until N_{USER}=0, which corresponds to the standard timing advance. Since the further communication is cyphered, eavesdropping is not effective, and it may not be necessary to apply the additional time offset to the encrypted communication.

The value of the additional time offset may be decreased or increased such that the decrease or increase is within a supported range of the timing advance update. Depending on the initially applied value of the additional time offset, decreasing of the additional time offset until N_{USER}=0 may need at least a few steps with corresponding MAC CE timing advance updates. This is related to the maximum supported by the MAC CE timing update range. If the decreasing (or increasing) is too rapid, i.e., beyond the supported MAC CE timing update range, the connection may be lost and a new random access procedure with RAR may be initialized, which in turn also means that the TA value provided in the RAR would be delivered in plain form, which is not desired. Thus, by gradually changing the value of the additional time offset, the RRC connection may be maintained and the related MAC CE timing advance updates are cyphered (encrypted), which maintains the desired security level.

Any security breach related to provisioning of the timing advance command in RAR in plain form may be neutralized, since the additional time offset is applied to the transmission time of the RACH preamble. Thus, eavesdropping is not efficient.

In block 1208, the apparatus determines a second uplink channel timing adjustment based on the timing advance command or a timing advance update by compensating for the decreased or increased or maintained value of the additional time offset. For example, the timing advance update may be received in a MAC CE timing advance command following the random access procedure, as the apparatus may be moving.

In block 1209, the apparatus transmits, to the radio access network node, an encrypted message by applying the second uplink channel timing adjustment compensated for the decreased or increased or maintained value of the additional time offset.

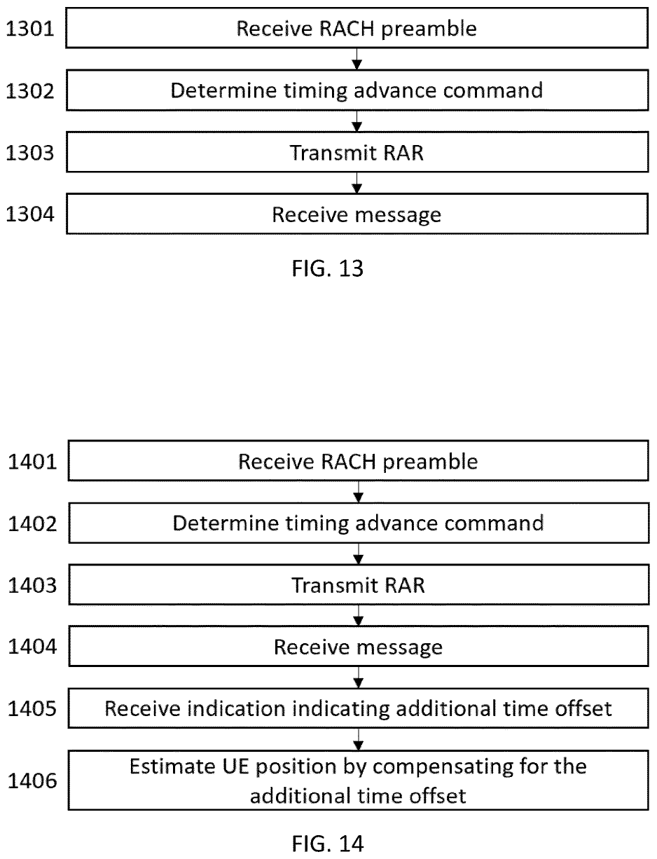

FIG. 13 illustrates a flow chart according to an example embodiment of a method performed by an apparatus 1800. For example, the apparatus 1800 may be, or comprise, or be comprised in, a radio access network node 104, 504.

Referring to FIG. 13, in block 1301, the apparatus receives a random access channel preamble from a user equipment 100, 500, wherein an additional time offset was applied to a transmission time of the random access channel preamble at the user equipment, wherein the additional time offset is different from timing corresponding to downlink channel timing adjustment. The additional time offset refers to T_{USER} described above.

In block 1302, the apparatus determines a timing advance command for the user equipment based on the random access channel preamble.

In block 1303, the apparatus transmits, to the user equipment, a random access response in response to receiving the random access channel preamble, wherein the random access response comprises the timing advance command.

In block 1304, the apparatus receives a message from the user equipment, wherein a first uplink channel timing adjustment based on the timing advance command was applied to a transmission of the message at the user equipment by compensating for the additional time offset applied for transmitting the random access channel preamble.

FIG. 14 illustrates a flow chart according to an example embodiment of a method performed by an apparatus 1800. For example, the apparatus 1800 may be, or comprise, or be comprised in, a radio access network node 104, 504.

Referring to FIG. 14, in block 1401, the apparatus receives a random access channel preamble from a user equipment 100, 500, wherein an additional time offset was applied to a transmission time of the random access channel preamble at the user equipment, wherein the additional time offset is different from timing corresponding to downlink channel timing adjustment. The additional time offset refers to T_{USER} described above.

In block 1402, the apparatus determines a timing advance command for the user equipment based on the random access channel preamble.

In block 1403, the apparatus transmits, to the user equipment, a random access response in response to receiving the random access channel preamble, wherein the random access response comprises the timing advance command.

In block 1404, the apparatus receives a message from the user equipment, wherein a first uplink channel timing adjustment based on the timing advance command was applied to a transmission of the message at the user equipment by compensating for the additional time offset applied for transmitting the random access channel preamble.

In block 1405, the apparatus receives, from the user equipment, an indication indicating the additional time offset and/or a pre-defined pattern used for modifying a value of the additional time offset.

In block 1406, the apparatus estimates a position of the user equipment by compensating for the additional time offset. For example, the apparatus may estimate the position based on the indication received from the user equipment.

In other words, after cyphering (encryption) is applied, the UE may inform the apparatus (RAN node) about the applied T_{USER} or N_{USER} value as part of UE capability information, and thus the apparatus (RAN node) may become aware of the additional time offset applied at the apparatus. The apparatus (RAN node) may then compensate for the additional time offset such that TA-based positioning techniques (e.g., E-CID) can still be used. For example, in case of emergency positioning, T_{USER} can be compensated at the apparatus (RAN node).

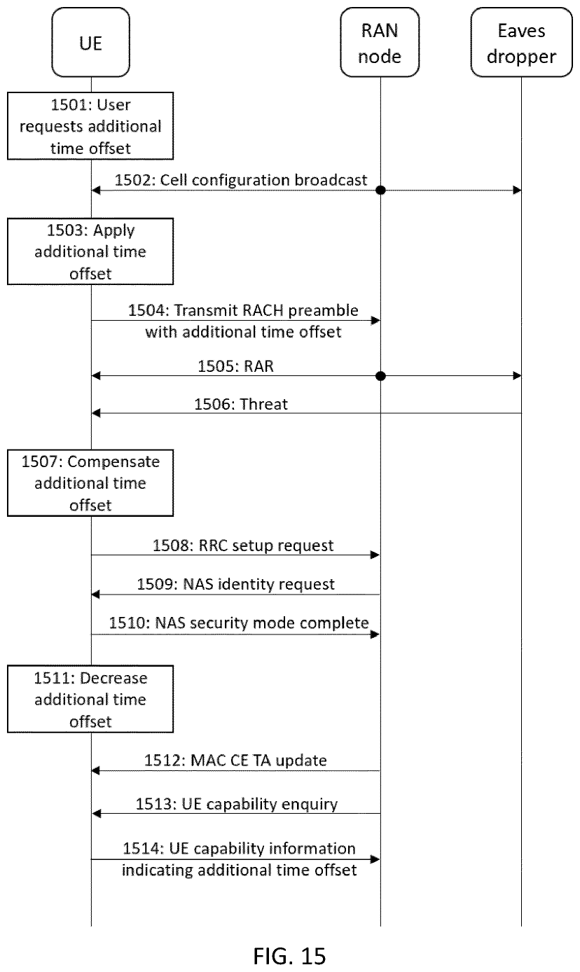

FIG. 15 illustrates a signal flow diagram according to an example embodiment.

Referring to FIG. 15, at 1501, a UE 100, 500 at position (x, y, z) receives a user input requesting additional security protection and specifying an additional time offset T_{USER}, which may be applicable for the next wireless connection.

At 1502, a RAN node 104, 504 (e.g., gNB) performs a cell configuration broadcast, which is detected and decoded by the UE 100, 500 and an eavesdropping device 502.

At 1503, the UE applies the additional time offset to a transmission time of a random access channel preamble. The additional time offset is different from timing corresponding to downlink channel timing adjustment.

At 1504, the UE transmits, to the RAN node, the random access channel preamble according to the transmission time applied with the additional time offset.

At 1505, the RAN node detects the RACH preamble and interprets it as originated from a false position (x′, y′, z′), i.e., not the true position (x, y, z) of the UE, since the RAN node is not aware of the additional time offset applied at the UE. This is reflected in the timing advance value determined by the RAN node.

At 1505, the RAN node transmits, to the UE, in response to receiving the RACH preamble, a random access response comprising a timing advance command. The timing advance command comprises the timing advance value determined by the RAN node based on the RACH preamble received from the UE. The timing advance command is provided in a plain form (i.e., without encryption). The RAR is received by the UE.

However, the RAR may also be intercepted by the eavesdropping device, which also understands it as related to position (x′, y′, z′), which in fact is a false position and differs from the true position (x, y, z).

At 1506, the eavesdropping device may initialize a threat to the UE and/or the user. However, as the eavesdropping device does not know the true position (x, y, z) of the UE, the threat may not be effective as it may target the false position (x′, y′, z′). Thus, security, safety and privacy benefits may be materialized.

At 1507, the UE determines an uplink channel timing adjustment based on the timing advance command by compensating for the additional time offset applied for transmitting the random access channel preamble, as the UE is aware of the incorrect TA value in the RAR. The compensation may be done before the next messages, such as RRC setup request and others, are sent in uplink and downlink direction.

At 1508, the UE transmit, to the RAN node, an RRC setup request message by applying the uplink channel timing adjustment compensated for the additional time offset.

At 1509, the RAN node transmits a non-access stratum (NAS) identity request message to the UE.

At 1510, the UE transmits a NAS security mode complete message to the RAN node. After this, encryption is applied both in downlink and uplink direction.

At 1511, the UE may decrease or increase the value of the additional time offset.

For example, the UE may decrease the T_{USER} value by 10% to gradually restore normal timing. In this case, N_{USER} may be set to 90% of the initial N_{USER} value. The T_{USER} value may be decreased or increased such that the decrease or increase is within the supported MAC CE timing advance update range, in order to not lose time synchronization.

The RAN node observes timing related to uplink channel timing adjustment. If a message from the UE arrives with some delay or in advance with respect to downlink channel timing adjustment, the RAN node initiates sending a MAC CE timing advance update with the proper time correction. Thus, UE motion, which impacts propagation delay time, is taken into account. For example, if the UE decreases the T_{USER} value (additional time offset), it will be observed by the RAN node as the UE approaching the RAN node, even though the UE may actually be stationary. This is because the overall TA was higher (normal TA+additional time offset), which also means that the distance was longer. Thus, if the next TA is lower, it may appear like UE motion towards the RAN node.

At 1512, the RAN node may transmit a MAC CE comprising a timing advance update to the UE, where the value of MAC CE timing compensation may be proportional to the changed (decreased or increased) T_{USER} value. Thus, changes in the T_{USER} value will seem like UE motion as observed by the RAN node (even though the UE may actually be stationary), which may be compensated by the MAC CE TA correction with a value corresponding to the change made to the T_{USER} value (e.g., 10% of T_{USER}, if the UE decreased the T_{USER} value by 10%).

MAC CE timing advance update initiated by standard UE motion has no impact on T_{USER} value or its changes.

The reduction of the T_{USER} value may be continued until T_{USER}=0, which means the UE being at the true position (x, y, z). Afterwards, MAC CE TA updates have no impact on further message exchanges.

At 1513, the RAN node may transmit a UE capability enquiry to the UE to request the UE capability information of the UE.

At 1514, in response to the UE capability enquiry, the UE may transmit the UE capability information to the RAN node in an encrypted message.

The UE capability information may comprise information about the additional time offset and/or pattern applied at the UE for decreasing or increasing the additional time offset. Based on this information, the RAN node may confirm the position of the UE at the true position (x, y, z). Further usage of the additional time offset, if needed, may be supported without any impact at the RAN node, as the RAN node can now compensate its effect. For example, the RAN node may estimate a position of the UE by compensating for the additional time offset.

The blocks, related functions, and information exchanges (messages) described above by means of FIGS. 6-15 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

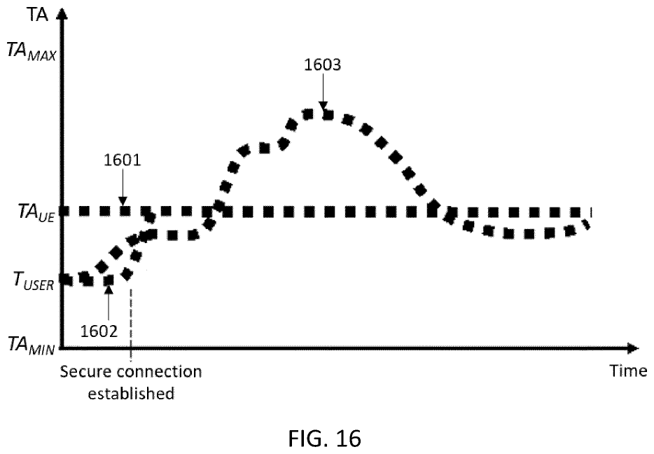

FIG. 16 illustrates an example of possible UE motion patterns caused by the additional time offset (i.e., T_{USER} or N_{USER}), as seen at the network side (i.e., at the RAN node).

1601 refers to the standard application (i.e., no additional time offset applied), which means that the TA value received the in RAR timing advance command corresponds to the true position or distance of the UE, i.e., TA_{UE}. The TA_{UE} value is not changed, which in practice means that the UE is stationary.

1602 refers to an example embodiment, in which the additional time offset is applied until a secure connection is established. The secure connection may mean that cyphering (encryption) is applied in uplink and downlink direction.

1603 refers to an example embodiment, in which the UE may maintain the specified T_{USER} or N_{USER} pattern for the entire connection time, wherein the pattern may simulate UE motion within the given cell, i.e., within limits defined by TA_{MIN} and TA_{MAX}.

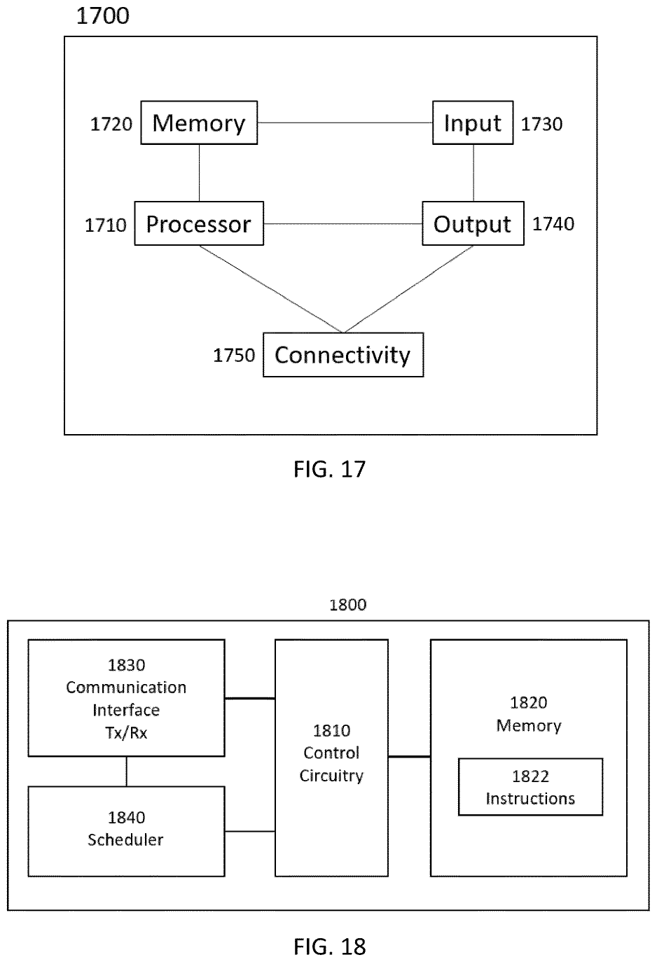

FIG. 17 illustrates an example of an apparatus 1700 comprising means for performing one or more of the example embodiments described above. For example, the apparatus 1700 may be, or comprise, or be comprised in, a user equipment 100, 500.

The user equipment may also be called a wireless communication device, a subscriber unit, a mobile station, a remote terminal, an access terminal, a user terminal, a terminal device, or a user device.

The apparatus 1700 may comprise a circuitry or a chipset applicable for realizing one or more of the example embodiments described above. For example, the apparatus 1700 may comprise at least one processor 1710. The at least one processor 1710 interprets instructions (e.g., computer program instructions) and processes data. The at least one processor 1710 may comprise one or more programmable processors. The at least one processor 1710 may comprise programmable hardware with embedded firmware and may, alternatively or additionally, comprise one or more application-specific integrated circuits (ASICs).

The at least one processor 1710 is coupled to at least one memory 1720. The at least one processor is configured to read and write data to and from the at least one memory 1720. The at least one memory 1720 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The at least one memory 1720 stores computer readable instructions that are executed by the at least one processor 1710 to perform one or more of the example embodiments described above. For example, non-volatile memory stores the computer readable instructions, and the at least one processor 1710 executes the instructions using volatile memory for temporary storage of data and/or instructions. The computer readable instructions may refer to computer program code.

The computer readable instructions may have been pre-stored to the at least one memory 1720 or, alternatively or additionally, they may be received, by the apparatus, via an electromagnetic carrier signal and/or may be copied from a physical entity such as a computer program product. Execution of the computer readable instructions by the at least one processor 1710 causes the apparatus 1700 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 1700 may further comprise, or be connected to, an input unit 1730. The input unit 1730 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1730 may comprise an interface to which external devices may connect to.

The apparatus 1700 may also comprise an output unit 1740. The output unit may comprise or be connected to one or more displays capable of rendering visual content, such as a light emitting diode (LED) display, a liquid crystal display (LCD) and/or a liquid crystal on silicon (LCoS) display. The output unit 1740 may further comprise one or more audio outputs. The one or more audio outputs may be for example loudspeakers.

The apparatus 1700 further comprises a connectivity unit 1750. The connectivity unit 1750 enables wireless connectivity to one or more external devices. The connectivity unit 1750 comprises at least one transmitter and at least one receiver that may be integrated to the apparatus 1700 or that the apparatus 1700 may be connected to. The at least one transmitter comprises at least one transmission antenna, and the at least one receiver comprises at least one receiving antenna. The connectivity unit 1750 may comprise an integrated circuit or a set of integrated circuits that provide the wireless communication capability for the apparatus 1700. Alternatively, the wireless connectivity may be a hardwired application-specific integrated circuit (ASIC). The connectivity unit 1750 may also provide means for performing at least some of the blocks or functions of one or more example embodiments described above. The connectivity unit 1750 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

It is to be noted that the apparatus 1700 may further comprise various components not illustrated in FIG. 17. The various components may be hardware components and/or software components.

FIG. 18 illustrates an example of an apparatus 1800 comprising means for performing one or more of the example embodiments described above. For example, the apparatus 1800 may be an apparatus such as, or comprising, or comprised in, a radio access network node 104, 504.

The radio access network node may also be referred to, for example, as a network element, a next generation radio access network (NG-RAN) node, a NodeB, an eNB, a gNB, a base transceiver station (BTS), a base station, an NR base station, a 5G base station, an access node, an access point (AP), a cell site, a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 1800 may comprise, for example, a circuitry or a chipset applicable for realizing one or more of the example embodiments described above. The apparatus 1800 may be an electronic device comprising one or more electronic circuitries. The apparatus 1800 may comprise a communication control circuitry 1810 such as at least one processor, and at least one memory 1820 storing instructions 1822 which, when executed by the at least one processor, cause the apparatus 1800 to carry out one or more of the example embodiments described above. Such instructions 1822 may, for example, include computer program code (software). The at least one processor and the at least one memory storing the instructions may provide the means for providing or causing the performance of any of the methods and/or blocks described above.

The processor is coupled to the memory 1820. The processor is configured to read and write data to and from the memory 1820. The memory 1820 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 1820 stores computer readable instructions that are executed by the processor. For example, non-volatile memory stores the computer readable instructions, and the processor executes the instructions using volatile memory for temporary storage of data and/or instructions.

The computer readable instructions may have been pre-stored to the memory 1820 or, alternatively or additionally, they may be received, by the apparatus, via an electromagnetic carrier signal and/or may be copied from a physical entity such as a computer program product. Execution of the computer readable instructions causes the apparatus 1800 to perform one or more of the functionalities described above.

The memory 1820 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data, such as a current neighbour cell list, and, in some example embodiments, structures of frames used in the detected neighbour cells.

The apparatus 1800 may further comprise or be connected to a communication interface 1830, such as a radio unit, comprising hardware and/or software for realizing communication connectivity with one or more wireless communication devices according to one or more communication protocols. The communication interface 1830 comprises at least one transmitter (Tx) and at least one receiver (Rx) that may be integrated to the apparatus 1800 or that the apparatus 1800 may be connected to. The communication interface 1830 may provide means for performing some of the blocks for one or more example embodiments described above. The communication interface 1830 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

The communication interface 1830 provides the apparatus with radio communication capabilities to communicate in the wireless communication network. The communication interface may, for example, provide a radio interface to one or more wireless communication devices. The apparatus 1800 may further comprise or be connected to another interface towards a core network such as the network coordinator apparatus or AMF, and/or to the access nodes of the cellular communication system.

The apparatus 1800 may further comprise a scheduler 1840 that is configured to allocate radio resources. The scheduler 1840 may be configured along with the communication control circuitry 1810 or it may be separately configured.

It is to be noted that the apparatus 1800 may further comprise various components not illustrated in FIG. 18. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory (ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the embodiments.

### LIST OF ABBREVIATIONS

3G: third generation
4G: fourth generation
5G: fifth generation
5GC: fifth generation core network
6G: sixth generation
ADC: analog-to-digital converter
AMF: access and mobility management function
AN: access node
ASIC: application-specific integrated circuit
BBU: baseband unit
BTS: base transceiver station
CBRA: contention based random access
CFRA: contention free random access
CN: core network
CP: control plane
CSSP: customer-specific standard product
CU: central unit
DAC: digital-to-analog converter
DFE: digital front end
DL: downlink
DMRS: demodulation reference signal
DRAM: dynamic random-access memory
DSP: digital signal processor
DSPD: digital signal processing device
DU: distributed unit
E-CID: extended cell identity
EEPROM: electronically erasable programmable read-only memory
eNB: evolved Node B
EPC: evolved packet core
E-UTRA: evolved universal terrestrial radio access network
FPGA: field programmable gate array
GEO: geostationary earth orbit
gNB: next generation Node B
GPU: graphics processing unit
GSM: global system for mobile communications
HNB-GW: home node B gateway
HSPA: high-speed packet access
IoT: internet of things
L1: layer 1
L2: layer 2
L3: layer 3
LCD: liquid crystal display
LCOS: liquid crystal on silicon
LED: light emitting diode
LEO: low earth orbit
LMF: location management function
LTE: long term evolution
LTE-A: long term evolution advanced
M2M: machine-to-machine
MAC CE: MAC control element
MAC: medium access control
MEC: multi-access edge computing
MIMO: multiple input-multiple output
MME: mobility management entity
mMTC: machine-type communications
NFV: network function virtualization
NG-RAN: next generation radio access network
NR: new radio
PDA: personal digital assistant
PDCP: packet data convergence protocol
P-GW: packet data network gateway
PHY: physical
PLD: programmable logic device
PROM: programmable read-only memory
PSS: primary synchronization signal
RACH: random access channel
RAM: random-access memory
RAN: radio access network
RAP: radio access point
RAR: random access response
RedCap: reduced capability
RLC: radio link control
ROM: read-only memory
RRC: radio resource control
RRH: remote radio head
RU: radio unit
Rx: receiver
SCell: secondary cell
SCS: subcarrier spacing
SDAP: service data adaptation protocol
SDN: software defined networking
SDRAM: synchronous dynamic random-access memory
S-GW: serving gateway
SI: system information
SIM: subscriber identification module
SL: sidelink
SoC: system-on-a-chip
SRS: sounding reference signal
SSS: secondary synchronization signal
TA: timing advance
TRP: transmission and reception point
TRX: transceiver
Tx: transmitter
UE: user equipment
UL: uplink
UMTS: universal mobile telecommunications system
UP: user plane
UPF: user place function
UTRAN: UMTS radio access network
vCU: virtualized central unit
vDU: virtualized distributed unit
W-CDMA: wideband-code division multiple access

1. An apparatus comprising at least one processor, and at least one memory storing instructions that, when executed by the at least one processor, cause the apparatus at least to:
apply an additional time offset to a transmission time of a random access channel preamble, wherein the additional time offset is different from timing corresponding to downlink channel timing adjustment;
transmit, to a radio access network node, the random access channel preamble according to the transmission time applied with the additional time offset;
receive, from the radio access network node, a random access response in response to transmitting the random access channel preamble, wherein the random access response comprises a timing advance command;
determine a first uplink channel timing adjustment based on the timing advance command by compensating for the additional time offset applied for transmitting the random access channel preamble; and
transmit, to the radio access network node, a message by applying the first uplink channel timing adjustment compensated for the additional time offset.

2. The apparatus according to claim 1, further being caused to:
receive a user input indicating the additional time offset.

3. The apparatus according to any preceding claim further being caused to:
decrease or increase or maintain a value of the additional time offset;
determine a second uplink channel timing adjustment based on the timing advance command or a timing advance update by compensating for the decreased or increased or maintained value of the additional time offset; and
transmit, to the radio access network node, an encrypted message by applying the second uplink channel timing adjustment compensated for the decreased or increased or maintained value of the additional time offset.

4. The apparatus according to claim 3, wherein the value of the additional time offset is decreased or increased such that the decrease or increase is within a supported range of the timing advance update.

5. The apparatus according to any of claims 1-2, further being caused to:
transmit, to the radio access network node, an encrypted message by applying the first uplink channel timing adjustment.

6. The apparatus according to any of claims 1-2, further being caused to:
modify a value of the additional time offset according to a pre-defined pattern selected from a plurality of pre-defined patterns;
determine a second uplink channel timing adjustment based on the timing advance command or a timing advance update by compensating for the modified value of the additional time offset; and
transmit, to the radio access network node, an encrypted message by applying the second uplink channel timing adjustment compensated for the modified value of the additional time offset.

7. The apparatus according to claim 6, further being caused to:
determine, based on the timing advance command, a distance between the apparatus and the radio access network node,
wherein the value of the additional time offset is modified based on the distance between the apparatus and the radio access network node.

8. The apparatus according to any of claims 6-7, further being caused to:
transmit, to the radio access network node, an indication indicating the pre-defined pattern used for modifying the value of the additional time offset.

9. The apparatus according to any preceding claim, further being caused to:
transmit, to the radio access network node, an indication indicating the additional time offset.

10. The apparatus according to any preceding claim, wherein the apparatus comprises, or is comprised in, a user equipment.

11. An apparatus comprising at least one processor, and at least one memory storing instructions that, when executed by the at least one processor, cause the apparatus at least to:
receive a random access channel preamble from a user equipment, wherein an additional time offset was applied to a transmission time of the random access channel preamble at the user equipment, wherein the additional time offset is different from timing corresponding to downlink channel timing adjustment;
determine a timing advance command for the user equipment based on the random access channel preamble;
transmit, to the user equipment, a random access response in response to receiving the random access channel preamble, wherein the random access response comprises the timing advance command; and
receive a message from the user equipment, wherein a first uplink channel timing adjustment based on the timing advance command was applied to a transmission of the message at the user equipment by compensating for the additional time offset applied for transmitting the random access channel preamble.

12. The apparatus according to claim 11, further being caused to:
receive, from the user equipment, an indication indicating the additional time offset or a pre-defined pattern used for modifying a value of the additional time offset; and
estimate a position of the user equipment by compensating for the additional time offset.

13. The apparatus according to any of claims 11-12, wherein the apparatus comprises, or is comprised in, a radio access network node.

14. An apparatus comprising:
means for applying an additional time offset to a transmission time of a random access channel preamble, wherein the additional time offset is different from timing corresponding to downlink channel timing adjustment;
means for transmitting, to a radio access network node, the random access channel preamble according to the transmission time applied with the additional time offset;
means for receiving, from the radio access network node, a random access response in response to transmitting the random access channel preamble, wherein the random access response comprises a timing advance command;
means for determining a first uplink channel timing adjustment based on the timing advance command by compensating for the additional time offset applied for transmitting the random access channel preamble; and
means for transmitting, to the radio access network node, a message by applying the first uplink channel timing adjustment compensated for the additional time offset.

15. An apparatus comprising:
means for receiving a random access channel preamble from a user equipment, wherein an additional time offset was applied to a transmission time of the random access channel preamble at the user equipment, wherein the additional time offset is different from timing corresponding to downlink channel timing adjustment;
means for determining a timing advance command for the user equipment based on the random access channel preamble;
means for transmitting, to the user equipment, a random access response in response to receiving the random access channel preamble, wherein the random access response comprises the timing advance command; and
means for receiving a message from the user equipment, wherein a first uplink channel timing adjustment based on the timing advance command was applied to a transmission of the message at the user equipment by compensating for the additional time offset applied for transmitting the random access channel preamble.

16. A method comprising:
applying an additional time offset to a transmission time of a random access channel preamble, wherein the additional time offset is different from timing corresponding to downlink channel timing adjustment;
transmitting, to a radio access network node, the random access channel preamble according to the transmission time applied with the additional time offset;
receiving, from the radio access network node, a random access response in response to transmitting the random access channel preamble, wherein the random access response comprises a timing advance command;
determining a first uplink channel timing adjustment based on the timing advance command by compensating for the additional time offset applied for transmitting the random access channel preamble; and
transmitting, to the radio access network node, a message by applying the first uplink channel timing adjustment compensated for the additional time offset.

17. A method comprising:
receiving a random access channel preamble from a user equipment, wherein an additional time offset was applied to a transmission time of the random access channel preamble at the user equipment, wherein the additional time offset is different from timing corresponding to downlink channel timing adjustment;
determining a timing advance command for the user equipment based on the random access channel preamble;
transmitting, to the user equipment, a random access response in response to receiving the random access channel preamble, wherein the random access response comprises the timing advance command; and
receiving a message from the user equipment, wherein a first uplink channel timing adjustment based on the timing advance command was applied to a transmission of the message at the user equipment by compensating for the additional time offset applied for transmitting the random access channel preamble.

18. A non-transitory computer readable medium comprising program instructions which, when executed by an apparatus, cause the apparatus to perform at least the following:
applying an additional time offset to a transmission time of a random access channel preamble, wherein the additional time offset is different from timing corresponding to downlink channel timing adjustment;
transmitting, to a radio access network node, the random access channel preamble according to the transmission time applied with the additional time offset;
receiving, from the radio access network node, a random access response in response to transmitting the random access channel preamble, wherein the random access response comprises a timing advance command;
determining a first uplink channel timing adjustment based on the timing advance command by compensating for the additional time offset applied for transmitting the random access channel preamble; and
transmitting, to the radio access network node, a message by applying the first uplink channel timing adjustment compensated for the additional time offset.

19. A non-transitory computer readable medium comprising program instructions which, when executed by an apparatus, cause the apparatus to perform at least the following:
receiving a random access channel preamble from a user equipment, wherein an additional time offset was applied to a transmission time of the random access channel preamble at the user equipment, wherein the additional time offset is different from timing corresponding to downlink channel timing adjustment;
determining a timing advance command for the user equipment based on the random access channel preamble;
transmitting, to the user equipment, a random access response in response to receiving the random access channel preamble, wherein the random access response comprises the timing advance command; and
receiving a message from the user equipment, wherein a first uplink channel timing adjustment based on the timing advance command was applied to a transmission of the message at the user equipment by compensating for the additional time offset applied for transmitting the random access channel preamble.
